(19) United States
(12) Patent Application Publication
(10) Pub. No.: US 2011/0139947 A1
(43) Pub. Date: Jun. 16, 2011

(54) SPHERICAL PIVOT BEARING ASSEMBLY STRUCTURE AND HOLDER USING THE SAME

(75) Inventors: Yun-Ping Lee, Taipei County (TW); Wei-Jen Chiang, Taipei County (TW)

(73) Assignee: KINPO ELECTRONICS, INC., Taipei County (TW)

(21) Appl. No.: 12/689,496

(22) Filed: Jan. 19, 2010

(30) Foreign Application Priority Data
Dec. 15, 2009 (TW) 98142970

(51) Int. Cl. F16M 11/14; F16C 27/00

(52) U.S. Cl. 248/122.1; 384/535

(57) ABSTRACT

A spherical pivot bearing assembly structure and a holder using the same are provided. The spherical pivot bearing assembly structure comprises a spherical pivot, a bearing housing, a friction member, an elastic member and a fixing member, wherein the elastic member disposed between the friction member and the elastic member applies an elastic force on the friction member to force the friction member tightly against a spherical surface of the spherical pivot and uniformly distribute the loading applied on the friction member so as to prevent slippage of the friction member. The elastic member may be a spring shaped in coils, wherein the amount of coils can be adjusted as being applied to different types of electronic apparatuses in different dimensions.

### CROSS-REFERENCE TO RELATED APPLICATION

This application claims the priority benefit of Taiwan application serial no. 98142970, filed on Dec. 15, 2009. The entirety of the above-mentioned patent application is hereby incorporated by reference herein and made a part of specification.

### BACKGROUND OF THE INVENTION

1. Field of the Invention

The invention relates to a spherical pivot bearing assembly structure and a holder using the same. More particularly, the invention relates to a spherical pivot bearing assembly structure and a holder applied to an electronic apparatus.

2. Description of Related Art

Global positioning system (GPS) can provide precise positioning, speed, and time information by using satellite positioning signals. The GPS has been broadly applied to vehicle guidance apparatus or mobile phones.

A holder or a base is required for a vehicle guidance apparatus to fix the position thereof or supply power thereto. To operate the vehicle guidance apparatus conveniently, conventional holders or bases usually integrate with spherical pivots or universal joints such that users can adjust the position and the orientation of the holders or the bases in multi-angle. A structure using a spherical pivot to serve as a pivot joint may adopt a rubber as a friction member, which is capable of providing resistance in pivoting the spherical pivot and fixing the orientation of the spherical pivot. However, the contact manner and the arrangement between the rubber and the spherical pivot may cause a non-uniform loading, or otherwise, result in a slippage of the rubber as pivoting the spherical pivot.

Different degrees of resistance are required for electronic apparatuses in different weights so as to provide a preferred carrying capability. Nevertheless, the conventional pivot joint is incapable of providing different carrying capabilities and resistance to different types of electronic apparatuses. Designing an exclusive pivot joint for each type of electronic apparatus may increase the manufacturing cost.

### SUMMARY OF THE INVENTION

The present invention relates to a spherical pivot bearing assembly structure and a holder using the same, wherein a spring is disposed between a rubber friction and a fixing member to produce an elastic force for enhancing the friction between the rubber friction member and a spherical pivot and thereby preventing slippage therebetween. Furthermore, resistance in pivoting the spherical pivot can be adjusted by changing the number of coils of the spring to comply with electronic apparatuses of different types and improve reception of users in operating the spherical pivot bearing assembly structure.

As embodied and broadly described herein, a spherical pivot bearing assembly structure comprising a spherical pivot, a bearing housing, a friction member, a fixing member and an elastic member is provided. The spherical pivot has a spherical body and an axial shaft. The bearing housing has a trough for installing the spherical body of the spherical pivot. The friction member is disposed in the bearing housing, and the friction member has a curved surface contacted with the spherical body. The fixing member is disposed at a side of the friction member and fixed on the bearing housing for fixing a relative position between the friction member and the spherical body. The elastic member is disposed between the friction member and the fixing member for applying an elastic force to the friction member to force the friction member tightly against the spherical body. The friction member has a circular ring surrounding the curved surface, and the fixing member is against the circular ring to fix the friction member. In an embodiment of the present invention, the circular ring has a plurality of grooves disposed on locations corresponding to screw holes of the bearing housing. The elastic member may be a spring disposed inside the circular ring. The friction member is made of, for example, rubber.

In an embodiment of the present invention, the friction member has a first protrusion portion extending toward the fixing member, the fixing member has a second protrusion portion located at the center of the fixing member and extending toward the friction member, and the second protrusion portion is against the first protrusion portion.

In an embodiment of the present invention, the spherical pivot bearing assembly structure further comprises a lid fixed on the bearing housing, wherein the bearing housing has an accommodating space for accommodating the friction member, the fixing member and the elastic member, and the lid covers an opening of the accommodating space.

The application also provides a holder using the aforementioned spherical pivot bearing assembly structure to carry an electronic apparatus. The holder comprises a spherical pivot bearing assembly structure and a base. The spherical pivot bearing assembly structure comprises a spherical pivot, a bearing housing, a friction member, a fixing member and an elastic member. The spherical pivot has a spherical body and an axial shaft, wherein an end of the axial shaft is connected to the spherical body. The bearing housing has a trough for installing the spherical body of the spherical pivot. The friction member is disposed in the bearing housing, wherein the friction member has a curved surface contacted with the spherical body, and the friction member has a circular ring surrounding the curved surface. The fixing member is disposed at a side of the friction member and fixed on the bearing housing for fixing a relative position between the friction member and the spherical body, wherein the fixing member is against the circular ring to fix the friction member. The elastic member is disposed between the friction member and the fixing member for applying an elastic force to the friction member to force the friction member tightly against the spherical body. The lid is fixed on the bearing housing, wherein the bearing housing has an accommodating space for accommodating the friction member, the fixing member and the elastic member, and the lid covers an opening of the accommodating space. Another end of the axial shaft is connected with the base.

In view of the above, the present invention disposes a spring in the spherical pivot bearing assembly structure for enhancing the friction between the friction member and the spherical pivot so as to uniformly distribute the loading applied on the friction member, reliably contact the friction member with the spherical pivot and prevent slippage caused by pivoting of the spherical pivot. In addition, designers may adjust the resistance in pivoting the spherical pivot by changing the number of coils of the spring to meet different specifications and design or using requirements.

In order to make the aforementioned and other features and advantages of the invention more comprehensible, embodiments accompanying figures are described in detail below.

### BRIEF DESCRIPTION OF THE DRAWINGS

The accompanying drawings are included to provide a further understanding of the invention and are incorporated in and constitute a part of this specification. The drawings illustrate embodiments of the invention and, together with the description, serve to explain the principles of the invention.

FIG. 1 is a schematic exploded view of a spherical pivot bearing assembly structure according to an embodiment of the present invention.

FIG. 2A is a schematic side view of the friction member in FIG. 1.

FIG. 2B is a cross-sectional view of the friction member in FIG. 1.

FIG. 3 is a schematic view of a holder of an electronic apparatus according to another embodiment of the present invention.

FIG. 4 is a cross-sectional view of the holder in FIG. 3.

### DESCRIPTION OF EMBODIMENTS

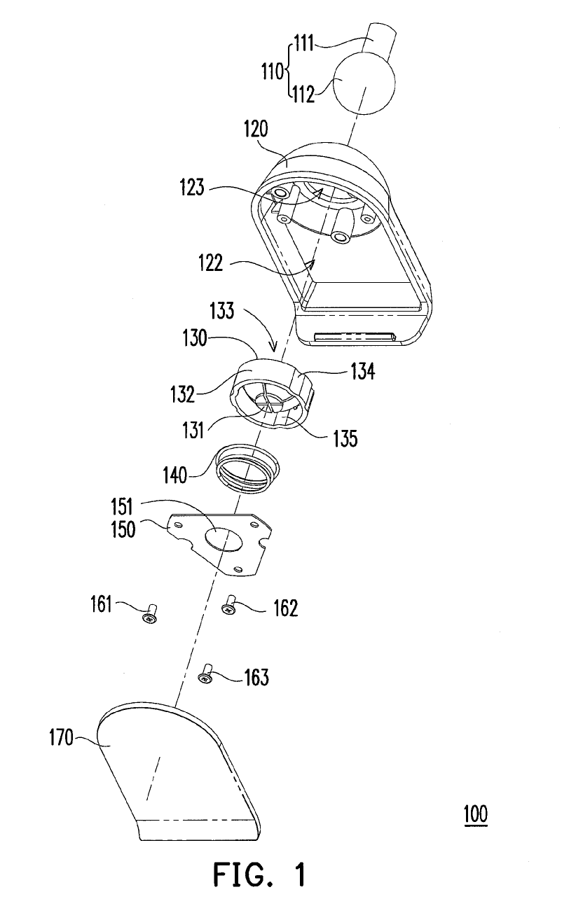

Referring to FIG. 1, which is a schematic exploded view of a spherical pivot bearing assembly structure according to an embodiment of the present invention. The spherical pivot bearing assembly structure 100 mainly comprises a spherical pivot 110, a bearing housing 120, a friction member 130, an elastic member 140 and a fixing member 150. A lid 170 is provided to cover an accommodating space 122 of the bearing housing 120. The spherical pivot 110 has a spherical body 112 and an axial shaft 111 connected to the spherical body 112. The spherical body 112 is installed in the accommodating space 122 of the bearing housing, wherein a trough 123 of the bearing housing 120 is used for containing the spherical body 112 of the spherical pivot 110 and a diameter of the opening of the trough 123 is less than a diameter of the spherical body 112 so as to restrict the spherical body 112 in the bearing housing 120. The friction member 130 and the elastic member 140 are located between the fixing member 150 and the spherical body 112, wherein the friction member 130 has a curved surface 133 facing and being in contact with the spherical body 112, so as to apply a friction resistance to the spherical body 112 and then produce a supporting force for locating the orientation of the spherical pivot 110 when the spherical body 112 pivots relative to the bearing housing 120.

The fixing member 150 is fixed on the bearing housing 120 via screws 161-163 for fixing a relative position between the friction member 130 and the spherical body 112 and restraining the elastic member 140 between the fixing member 150 and the friction member 130. The friction member 130 has a first protrusion portion 131 located at the center of the friction member 130 and extending toward the fixing member, and the fixing member 150 has a second protrusion portion 151 located at the center of the fixing portion and extending toward the friction member 130, wherein the second protrusion portion 151 presses against the first protrusion portion 131, so as to apply pressure to the friction member 130, locate the friction member 130 and enhance the normal force applied on the spherical body 112. The friction member 130 has a circular ring 132 surrounding the curved surface 133 and extending toward the fixing member 150, wherein the fixing member 150 presses against the circular ring 132 to fixing the position of the friction member 130 and thereby prevent the friction member 130 from slippage caused by pivoting the spherical pivot 110.

The elastic member 140 may be a spring surrounding the first protrusion portion 131, wherein the fixing member 150 presses the elastic member 140 to apply an elastic force to the friction member 130 to force the friction member 130 tightly against the spherical body 112. The normal force applied by the friction member 130 to the spherical body 112 is increased by the elastic force and therefore the friction between the friction member 130 and the spherical body 112 can be enhanced to improve the effect of locating the orientation of the spherical body 112. The fixing member 150 provides normal pressure to the center portion and the peripheral portion of the friction member 130, while the elastic member 140 provides normal pressure to a peripheral of the first protrusion portion 131. Therefore, the loading distribution applied on a side of the friction member 130 facing the fixing member is more uniform, and thus the relative position between the friction member 130 and the spherical body 112 is stable and the slippage caused by pivoting the spherical body 112 is prevented. The elastic member 140 may be formed by compliant material such as rubber, while the embodiment is not limited thereto.

Furthermore, owing to low cost, and the number of coils or the coefficient of elasticity of the spring can be adjusted according to design requirements. The resistance of operating the spherical pivot bearing assembly structure 100 can be adjusted by change specifications of the elastic member 140, so as to comply with electronic apparatuses in different weight or meet various using requirements and provide much convenience in design. The friction member 130, the elastic member 140 and the fixing member 150 are disposed in the accommodating space 122 of the bearing housing 120. Except covering the accommodating space 122 of the bearing housing 120, the lid 170 can also be capable of carrying an electronic apparatus. A power adapter of the electronic apparatus can also be integrated with the lid 170. The present embodiment is not limited to said conditions.

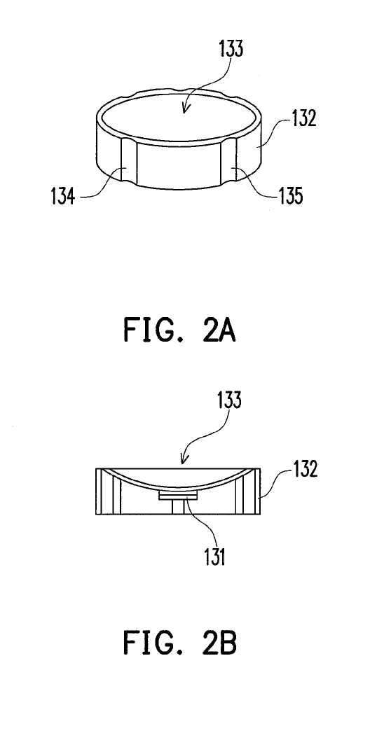

Plural grooves 134 and 135 can be formed on the circular ring 132 of the friction member 130 according to the mechanism design of the bearing housing 120, wherein the grooves 134 and 135 are corresponding to screw holes of the bearing housing 120 or other relative structures, while the disposition of the grooves 134 and 135 is optional and unrelated with the function of the friction member 130. The structure of the friction member 130 is illustrated in FIGS. 2A and 2B. FIG. 2A is a schematic side view of the friction member in FIG. 1. FIG. 2B is a cross-sectional view of the friction member in FIG. 1. As shown in FIG. 2A, the friction member 130 has the curved surface 133 to contact with the surface of the spherical body 12, while the circular ring 132 has grooves 134 and 135. As shown in FIG. 2B, the curved surface 133 of the friction member 130 is in a bowl-shape, while the center portion of the friction member 130 at the other side has the first protrusion portion 131.

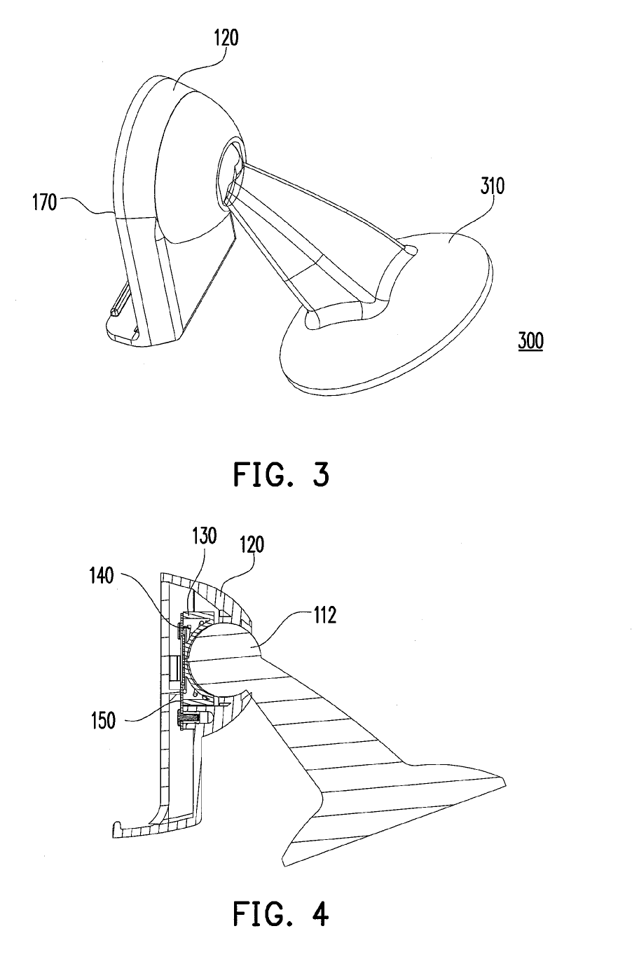

FIG. 3 is a schematic view of a holder of an electronic apparatus according to another embodiment of the present invention. The pivotable holder 300 can be fabricated by integrating the spherical pivot bearing assembly structure 100 with a base 310, and the lid 170 can be used for carrying the electronic apparatus such as a vehicle guidance apparatus or a mobile phone. The orientation of the bearing housing 120 can be adjusted according to using requirements, and the base 310 can be situated on an applicable position. FIG. 4 is a cross-sectional view of the holder in FIG. 3. Referring to FIG. 4, the friction member 130 and the elastic member 140 are disposed between the fixing member 150 and the spherical body 112, wherein the friction member 130 contacts with the surface of the spherical body 112 to apply a friction resistance to the spherical body 112, and the elastic member 140 surrounds the bowl-shaped portion of the friction member 130 to uniformly distribute the loading applied on the friction member 130 and prevent the problem of slippage.

Furthermore, it is noted that the spherical pivot bearing assembly structure of the present invention can be applied to various types of pivot joints and is not limited to the aforementioned holder of a guidance apparatus.

In summary, the present invention uses a spring to locate the friction member, uniformly distribute the loading applied on the friction member, and keep the friction member tightly contacting with the surface of the spherical body, and thus the problem of slippage caused by pivoting the spherical pivot can be prevented. Moreover, users may adjust the resistance of pivoting the spherical pivot by change the number of coils or the coefficient of elasticity of the elastic member, so as to comply with electronic apparatuses in different weight or meet various using requirements, and thereby provide much convenience in use.

Although the invention has been described with reference to the above embodiments, it will be apparent to one of the ordinary skill in the art that modifications to the described embodiment may be made without departing from the spirit of the invention. Accordingly, the scope of the invention will be defined by the attached claims not by the above detailed descriptions.

What is claimed is:

1. A spherical pivot bearing assembly structure, comprising:
a spherical pivot having a spherical body;
a bearing housing having a trough for installing the spherical body of the spherical pivot;
a friction member disposed in the bearing housing, the friction member having a curved surface contacted with the spherical body, the friction member having a circular ring surrounding the curved surface;
a fixing member disposed at a side of the friction member and fixed on the bearing housing for fixing a relative position between the friction member and the spherical body, wherein the fixing member is against the circular ring to fix the friction member; and
an elastic member disposed between the friction member and the fixing member, the elastic member applying an elastic force to the friction member to force the friction member tightly against the spherical body.

2. The spherical pivot bearing assembly structure as claimed in claim 1, wherein the circular ring has a plurality of grooves disposed on locations corresponding to screw holes of the bearing housing.

3. The spherical pivot bearing assembly structure as claimed in claim 2, wherein the elastic member is a spring disposed inside the circular ring.

4. The spherical pivot bearing assembly structure as claimed in claim 1, wherein the friction member has a first protrusion portion extending toward the fixing member, the fixing member has a second protrusion portion located at the center of the fixing member and extending toward the friction member, and the second protrusion portion is against the first protrusion portion.

5. The spherical pivot bearing assembly structure as claimed in claim 2, wherein the friction member has a first protrusion portion extending toward the fixing member, the fixing member has a second protrusion portion located at the center of the fixing member and extending toward the friction member, and the second protrusion portion is against the first protrusion portion.

6. The spherical pivot bearing assembly structure as claimed in claim 5, wherein the elastic member is a spring surrounding the first protrusion portion.

7. The spherical pivot bearing assembly structure as claimed in claim 1, wherein the spherical pivot further has an axial shaft, and an end of the axial shaft is connected with the spherical body.

8. The spherical pivot bearing assembly structure as claimed in claim 7, wherein another end of the axial shaft is connected with a base.

9. The spherical pivot bearing assembly structure as claimed in claim 1, further comprising a lid fixed on the bearing housing, wherein the bearing housing has an accommodating space for accommodating the friction member, the fixing member and the elastic member, and the lid covers an opening of the accommodating space.

10. The spherical pivot bearing assembly structure as claimed in claim 1, wherein the friction member is made of rubber.

11. A holder suitable for carrying an electronic apparatus, the holder comprising:
a spherical pivot bearing assembly structure, comprising:
a spherical pivot having a spherical body and an axial shaft, wherein an end of the axial shaft is connected to the spherical body;
a bearing housing having a trough for installing the spherical body of the spherical pivot;
a friction member disposed in the bearing housing, the friction member having a curved surface contacted with the spherical body, the friction member having a circular ring surrounding the curved surface;
a fixing member disposed at a side of the friction member and fixed on the bearing housing for fixing a relative position between the friction member and the spherical body, wherein the fixing member is against the circular ring to fix the friction member;
an elastic member disposed between the friction member and the fixing member, the elastic member applying an elastic force to the friction member to force the friction member tightly against the spherical body; and
a lid fixed on the bearing housing, wherein the bearing housing has an accommodating space for accommodating the friction member, the fixing member and the elastic member, and the lid covers an opening of the accommodating space; and
a base connected with another end of the axial shaft.

12. The holder as claimed in claim 11, wherein the circular ring has a plurality of grooves disposed on locations corresponding to screw holes of the bearing housing.

13. The holder as claimed in claim 12, wherein the friction member has a first protrusion portion extending toward the fixing member, the fixing member has a second protrusion portion located at the center of the fixing member and extending toward the friction member, and the second protrusion portion is against the first protrusion portion.
